(19) United States
(12) Patent Application Publication
(10) Pub. No.: US 2026/0109062 A1
(43) Pub. Date: Apr. 23, 2026

(54) SCISSORS BLADE STRUCTURE AND ELECTRIC SCISSORS

(71) Applicant: DongGuan Koham Industrial Co., Ltd., Dongguan (CN)

(72) Inventors: Xianpeng Ma, Dongguan (CN); Fuwei Liu, Dongguan (CN)

(21) Appl. No.: 19/428,201

(22) Filed: Dec. 21, 2025

(30) Foreign Application Priority Data
Jul. 11, 2025 (CN) 202521455873.1

(51) Int. Cl. B26B 13/28; B26B 13/06; B26B 15/00

(52) U.S. Cl. CPC B26B 13/28; B26B 13/06; B26B 15/00

(57) ABSTRACT

A scissors blade structure and a pair of electric scissors are provided, and relate to the technical field of scissors. The scissors blade structure includes a first blade, a second blade, and a connection shaft. The first blade is provided with a first connection hole. The second blade is provided with a second connection hole. One end of the connection shaft is connected with a stop cap portion, and another end of the connection shaft is connected with a fastener after sequentially passing through the first connection hole and the second connection hole. The fastener is screwed to a third shaft section in an axial direction of the third shaft section of the connection shaft. The third shaft section is further provided with an anti-detachment shaft. The anti-detachment shaft is connected with an anti-detachment cap portion.

### TECHNICAL FIELD

The present disclosure relates to the technical field of scissors, and in particular, to a scissors blade structure and a pair of electric scissors.

### BACKGROUND

In an existing literature, Chinese utility model No. CN213523146U provides an electric scissors blade structure, which includes a movable blade and a fixed blade. Both the movable blade and the fixed blade are provided with connection holes. The movable blade is connected with a straight swing tooth which is provided with a circular hole matching the connection hole. A protrusion is provided at a front end of the straight swing tooth, and an insertion hole matching the protrusion is formed in the movable blade. A heat dissipation hole is formed in a front portion of the movable blade. A pin is arranged between the movable blade, the straight swing tooth, and the fixed blade for connection. The movable blade and the straight swing tooth are fixedly connected, and the movable blade and the fixed blade are screwed. A fixing hole is formed in a rear portion of the fixed blade. An anti-looseness screw clamped with one end of the pin is arranged in the fixing hole.

A setting to prevent loosening of the connection between the movable blade and the fixed blade: a square gasket with a rounded corner is arranged at a bottom of a nut of the anti-looseness screw. An annular insection is provided at one end of the pin that is located on the fixed blade. An insection matching the annular insection is provided on an end surface of one side of the gasket.

This setting prevents loosening of the connection between the movable blade and the fixed blade and requires an additional mounting space to be reserved for a gasket with teeth.

Chinese utility model No. CN211832012U provides a "blade mechanism and electric scissors with the blade mechanism", and provides an anti-detachment setting for a fixed blade and a movable blade: a rotating shaft assembly passes through the fixed blade and the movable blade respectively. The rotating shaft assembly further includes an oil storage sheet and a blade shaft. The oil storage sheet is assembled between the fixed blade and the movable blade, and the blade shaft sequentially passes through the fixed blade, the oil storage sheet, and the movable blade. The rotating shaft assembly further includes a nut which is threaded connection with the blade shaft and resists against the movable blade. The rotating shaft assembly further includes an arc-shaped gasket which is clamped between the nut and the movable blade. The arc-shaped gasket has a bending curvature and bends towards the nut. The nut provides a pre-tightening force to the arc-shaped gasket, and the arc-shaped gasket relies on its own deformation to provide a pre-tightening force to the movable blade. The rotating shaft assembly further includes a second screw which is connected to one end of the blade shaft that is away from an oil passage and resists against the nut, so as to prevent the nut from being separated from the movable blade due to its own vibrations during use, thereby affecting the tightness of the movable blade and the fixed blade.

This anti-detachment setting keeps the space occupation on and near the blade shaft as much as possible, so that a small space is occupied. However, the anti-detachment effect of this anti-detachment setting is poor in actual use. After long-time use, screwing looseness easily occurs.

### SUMMARY

To overcome the foregoing shortcomings, the present disclosure provides a scissors blade structure that occupies a small space and can better prevent a blade from being loosened, and a pair of electric scissors applying the scissors blade structure.

To achieve the above objectives, the present disclosure provides the following technical solutions: a scissors blade structure includes a first blade, a second blade, and a connection structure. The first blade and the second blade are rotatably connected through the connection structure; the connection structure includes a connection shaft; the first blade is provided with a first connection hole that cooperates with the connection shaft; the second blade is provided with a second connection hole that cooperates with the connection shaft; one end of the connection shaft is connected with a stop cap portion corresponding to the first blade, and another end of the connection shaft is connected with a fastener after sequentially passing through the first connection hole and the second connection hole; and the fastener corresponds to the second blade.

The connection shaft includes a third shaft section that cooperates with the fastener.

The fastener is screwed to the third shaft section in an axial direction of the third shaft section, and is configured to move in a direction close to the stop cap portion and the second blade when the fastened is tightened.

An anti-detachment shaft is further arranged on the third shaft section, and is connected with an anti-detachment cap portion.

The anti-detachment shaft is screwed to the third shaft section in the axial direction of the third shaft section, and the anti-detachment cap portion is configured to move in a direction close to the stop cap portion and the fastener when the anti-detachment shaft is tightened.

A thread direction of the anti-detachment shaft and a thread direction of the fastener are mutually in a left-hand thread setting.

The present disclosure further provides the following technical solution: A pair of electric scissors, including the foregoing scissors blade structure.

Compared with the existing art, this technical solution has the beneficial effects: due to the right-hand and left-hand thread setting of the fastener and the anti-detachment shaft, anti-detachment stopping can be implemented while the fastener and the anti-detachment shaft are tightened: if the fastener is in a right-hand thread setting, the fastener will rotate (anticlockwise) in a left-hand direction during loosening. During the rotation, the anti-detachment shaft can be driven to rotate. If the anti-detachment shaft is in a left-hand thread setting, threads will be tightened along with the anticlockwise rotation, so as to prevent the fastener from rotating and achieve a good anti-loosening effect.

The additional aspects and advantages of the present disclosure will be set forth in part in the description below, parts of which will become apparent from the description below, or will be understood by the practice of the present disclosure.

### BRIEF DESCRIPTION OF THE DRAWINGS

To describe the technical solutions in the embodiments of the present disclosure or in the related art more clearly, the following briefly introduces the accompanying drawings for describing the embodiments or the related art. Apparently, the accompanying drawings in the following description show merely some embodiments of the present disclosure, and a person of ordinary skill in the art may still derive other drawings from the accompanying drawings without creative efforts.

FIG. 1 is a schematic structural diagram of electric scissors of the present disclosure;

FIG. 2 is another schematic structural diagram of electric scissors of the present disclosure;

FIG. 3 is a schematic structural diagram of a scissors blade structure of the present disclosure;

FIG. 4 is a structurally cross-sectional view of FIG. 3 in a direction A-A;

FIG. 5 is a structural exploded view of a scissors blade structure of the present disclosure;

FIG. 6 is another structural exploded view of a scissors blade structure of the present disclosure; and

FIG. 7 is a schematic structural diagram of a connection shaft in the present disclosure.

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are some of the embodiments of the present disclosure rather than all the embodiments. All other embodiments obtained by a person of ordinary skill in the art based on the disclosed embodiments without creative efforts shall fall within the protection scope of the present disclosure.

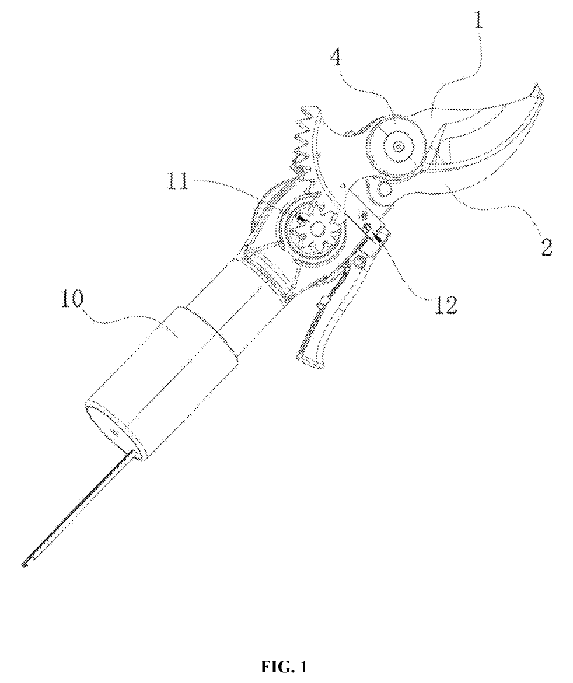

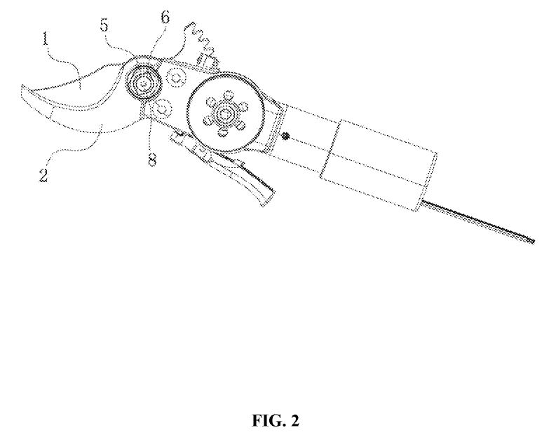

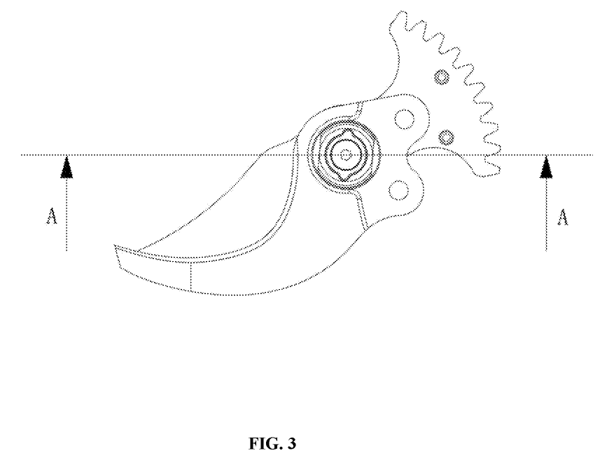

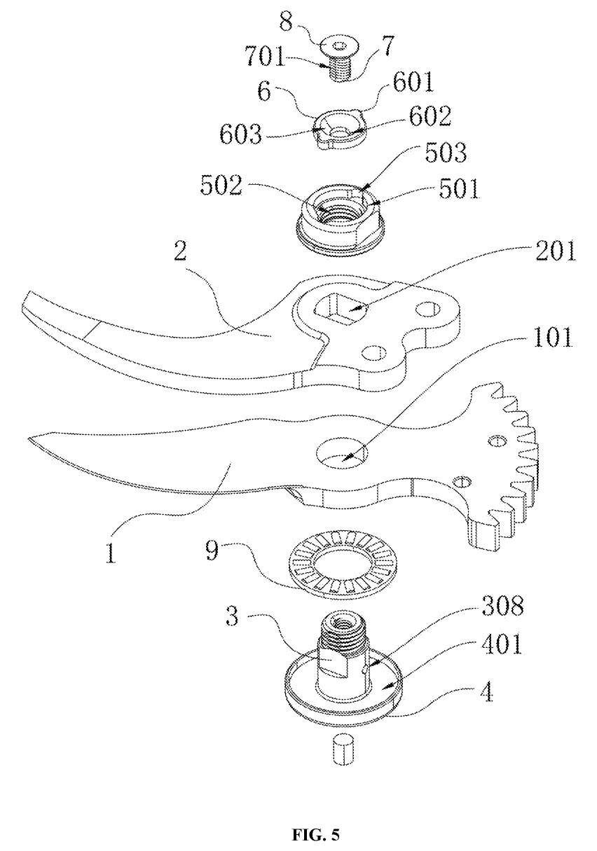

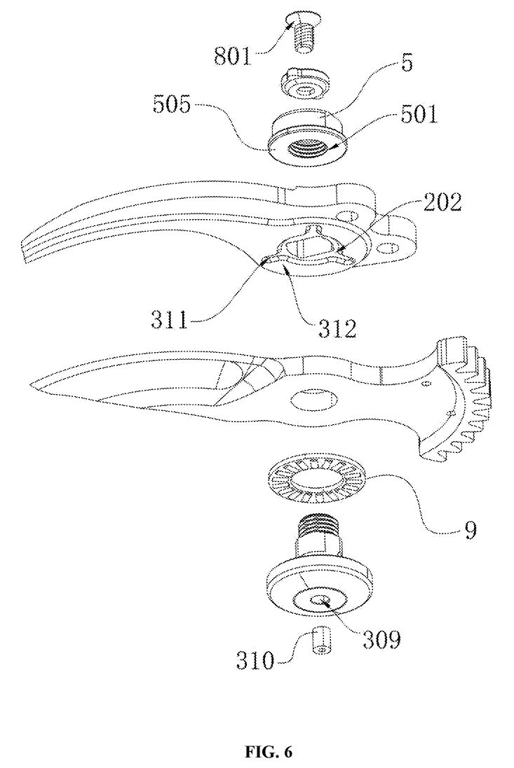

Referring to FIG. 1 to FIG. 7, a scissors blade structure includes a first blade 1, a second blade 2, and a connection structure. The first blade 1 and the second blade 2 are rotatably connected through the connection structure. The rotatable connection between the first blade 1 and the second blade 2 can implement a cutting action and a blade opening action.

The blade opening action is relative to the cutting action. The cutting action is reducing an opening degree of a scissors opening of scissors blades formed by the first blade 1 and the second blade 2, and the blade opening action is increasing the opening degree of the scissors opening of the scissors blades formed by the first blade 1 and the second blade 2.

The connection structure includes a connection shaft 3. The first blade 1 is provided with a first connection hole 101 that cooperates with the connection shaft 3, and the second blade 2 is provided with a second connection hole 201 that cooperates with the connection shaft 3. The connection shaft 3 is threaded into the first connection hole 101 and the second connection hole 201, so that the first blade 1 and the second blade 2 are rotatably connected through the connection shaft 3.

In this embodiment, one end of the connection shaft 3 is connected with a stop cap portion 4 corresponding to the first blade 1, and another end of the connection shaft 3 is connected with a fastener 5 after sequentially passing through the first connection hole 101 and the second connection hole 201. The fastener 5 corresponds to the second blade 2, and the first blade and the second blade 2 are maintained on the connection shaft 3 through the fastener 5 and the stop cap portion 4.

In some embodiments, the stop cap portion 4 is integrally formed on the connection shaft 3.

In some embodiments, the fastener 5 is detachably connected to the connection shaft 3.

In this embodiment, the connection shaft 3 includes a first shaft section 301 that cooperates with the first connection hole 101, a second shaft section 302 that cooperates with the second connection hole 201, and a third shaft section 303 that cooperates with the fastener 5.

The fastener 5 can be screwed to the third shaft section 303 in a screwing manner. The fastener 5 has a stop portion 505 corresponding to the second blade 2. When the fastener 5 is screwed to the third shaft section 303, the first blade 1 and the second blade 2 are limited from being separated correspondingly through the stop portion 505 and the stop cap portion 4, that is, to maintain the first blade 1 and the second blade 2 on the connection shaft 3.

In this embodiment, the third shaft section 303 has a first external thread 304 formed on an outer circumferential surface of the third shaft section.

The fastener 5 has a fastening hole 501 corresponding to the third shaft section 303. The fastening hole 501 internally has a first internal thread 502 that cooperates with the first external thread 304. After the third shaft section 303 is threaded into the fastening hole 501, the fastener 5 is in screwed fit with the first external thread 304 of the third shaft section through the first internal thread 502 in the fastening hole, so that the fastener 5 can be correspondingly screwed to the third shaft section 303.

In this embodiment, the third shaft section 303 is an end portion of the connection shaft 3, and the third shaft section 303 correspondingly has an end surface. The end surface of the third shaft section 303 is away from the stop cap portion 4.

The end surface of the third shaft section 303 is inwards sunken to form an anti-detachment hole 305 which internally has a second internal thread 306.

A thread direction of the second internal thread 306 is different from a thread direction of the first external thread 304: when the first external thread 304 is in a clockwise direction, the second internal thread 306 corresponds to an anticlockwise direction. Alternatively, when the first external thread 304 is a right-hand thread, the second internal thread 306 corresponds to a left-hand thread.

In this embodiment, the fastening hole 501 penetrates the fastener 5 in an axial direction of the connection shaft 3. The fastening hole 501 correspondingly has a far-end opening away from the stop cap portion and a near-end opening close to the stop cap portion. The third shaft section 303 is threaded into the fastening hole 501 from the near-end opening and is screwed to the fastener 5.

A guide sliding chute 503 communicated with the far-end opening is formed in one side of the fastener 5 that is away from the stop cap portion. The guide sliding chute 503 extends in the axial direction of the connection shaft 3 to form an axial guide sliding chute. That is, the axial guide sliding chute and the fastening hole are in a communicated state.

In this embodiment, the scissors blade structure further includes an axial transition member 6. The axial transition member 6 is configured to be threaded into the fastening hole 501 from the far-end opening. The axial transition member 6 is further configured to move in a direction close to the stop cap portion to press the third shaft section 303.

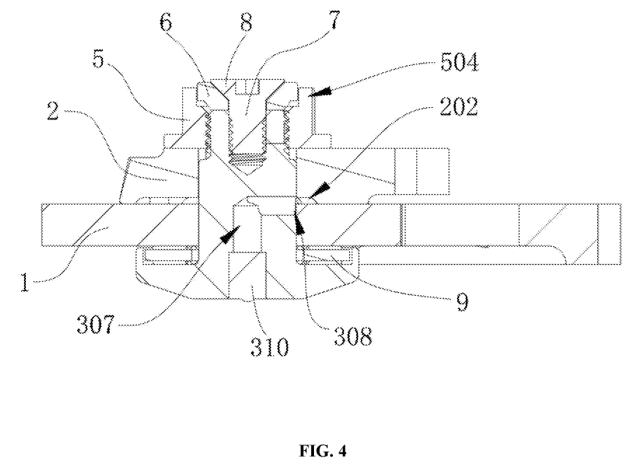

As shown in FIG. 4, in some embodiments, after being tightened, the fastener 5 extends beyond the third shaft section 303. That is, in a direction away from the stop cap portion, the fastener 5 has an extension portion 504 extending beyond the third shaft section 303.

In this embodiment, the axial transition member 6 is provided with a positioning portion 601 that cooperates with the guide sliding chute 503. The guide sliding chute 503 is configured to limit the axial transition member 6 with the positioning portion from rotating. That is, the axial transition member 6 cannot rotate around an axis of the connection shaft 3 that serves as a rotation center line.

In this embodiment, the scissors blade structure further includes an anti-detachment shaft 7 corresponding to the anti-detachment hole 305. The anti-detachment shaft 7 is connected with an anti-detachment cap portion 8 corresponding to the axial transition member 6. A second external thread 701 that cooperates with the second internal thread 306 is further provided on an outer circumferential surface of the anti-detachment shaft 7.

A shaft section of the anti-detachment shaft 7 that is provided with the second external thread 701 is threaded into the anti-detachment hole 305, and screwing fit between the anti-detachment shaft 7 and the connection shaft 3 is implemented through the second external thread 701 and the second internal thread 306 on the connection shaft.

In a process of screwing and tightening the anti-detachment shaft 7 and the connection shaft 3, and under the guidance of the guide sliding chute 503, the anti-detachment cap portion 8 is configured to push the axial transition member 6 in a direction close to the stop cap portion 4. Finally, the anti-detachment cap portion 8 compresses the axial transition member 6 onto the third shaft section 303, thus completing the tightening of the anti-detachment shaft 7 on the connection shaft 3.

In this embodiment, due to the right-hand and left-hand thread settings of first threads (the first internal thread and the first external thread) and second threads (the second internal thread and the second external thread), anti-detachment stopping can be implemented while the fastener 5 and the anti-detachment shaft 7 are tightened: if the fastener 5 is in a right-hand thread setting, the fastener 5 will rotate (anticlockwise) in a left-hand direction during loosening. During the rotation, the axial transition member 6 and the anti-detachment shaft 7 can be driven to rotate. If the anti-detachment shaft 7 is in a left-hand thread setting, threads will be tightened along with the anticlockwise rotation, so as to prevent the axial transition member 6 and the fastener 5 from rotating and provide a good anti-loosening effect.

When the anti-detachment shaft 7 is tightened onto the connection shaft 3 while the fastener 5 is screwed and tightened, the anti-detachment shaft 7 correspondingly drives the axial transition member 6 to move in the axial direction of the connection shaft 3 in the tightening process and finally compresses the axial transition member 6 onto the third shaft section 303. In the tightening process of anti-detachment shaft 7, there is a low reverse force applied to the fastener 5. Furthermore, after the anti-detachment shaft 7 is finally tightened, the anti-detachment shaft 7 is tightened on the connection shaft 3 through the anti-detachment cap portion 8 and the axial transition member 6. The tightening of the anti-detachment shaft 7 is mainly limited by a force applied by the connection shaft 3, thus reducing the force on the fastener 5 and better implementing tightening and loosening prevention. That is, by the arrangement of the axial transition member 6, when tightened, the anti-detachment shaft 7 can be transitioned through axial sliding of the axial transition member 6 on the fastener 5, so that the anti-detachment shaft 7 less affects the fastener 5. After being tightened, the anti-detachment shaft 7 can be limited by the rotation of the axial transition member 6 on the fastener 5, so that an anti-detachment effect of clockwise and anticlockwise threads can be well achieved.

In some embodiments, a designated force-bearing structure may be arranged on an outer side of the fastener 5 to cause the fastener 5 to be more easily tightened onto connection shaft 3 under a force. For example, the outer side of the fastener 5 is configured in a flat shaft shape, an external hexagonal shape, or the like.

In some embodiments, a designated force-bearing structure may be arranged on an outer side of the anti-detachment cap portion 8 to cause the anti-detachment shaft 7 to be more easily tightened onto connection shaft 3 under the force. For example, a crossed screwdriver hole, an internal hexagonal hole, or the like is formed in the outer side of the anti-detachment cap portion 8.

In some embodiments, a via hole 602 corresponding to the anti-detachment shaft 7 penetrates through the axial transition member 6, and the anti-detachment shaft 7 is correspondingly threaded into the anti-detachment hole 305 after passing through the via hole 602.

In some embodiments, the anti-detachment cap portion 8 has an anti-detachment slope 801 that is in contact with the axial transition member 6. The anti-detachment slope 801 tilts in a direction close to the anti-detachment cap portion and towards the anti-detachment shaft. For example, the anti-detachment slope 801 is designed as a conical or quasi conical shape as a whole.

The axial transition member 6 has a contact slope 603 that cooperates with the anti-detachment slope 801. In the tightening process of the anti-detachment shaft 7, rotational fit between the anti-detachment cap portion 8 and the axial transition member 6. After tightening, a force area between the axial transition member 6 and the anti-detachment cap portion 8 can be greatly enlarged, thereby achieving a better anti-detachment effect on the fastener 5, making it less likely for the fastener 5 to loosen after the fastener 5 is tightened.

In some embodiments, there are at least two guide sliding chutes 503.

In some embodiments, the connection shaft 3 is limited from rotating on the second blade 2, or it is understood that the second blade 2 cannot rotate on the connection shaft 3. That is, when the connection shaft 3 rotates relative to the first blade 1, the second blade 2 follows the connection shaft 3 to rotate relative to the first blade 1.

In this way, after the tightening, the rotation of the connection shaft 3 and the second blade 2 can be avoided, and a tightened anti-detachment structure composed of the fastener 5, the anti-detachment shaft 7, and the connection shaft 3 can be well maintained.

In some embodiments, a portion of an outer side of the second shaft section 302 may be removed to form an incomplete circular radial cross section, such as a circular cross section with a chamfer.

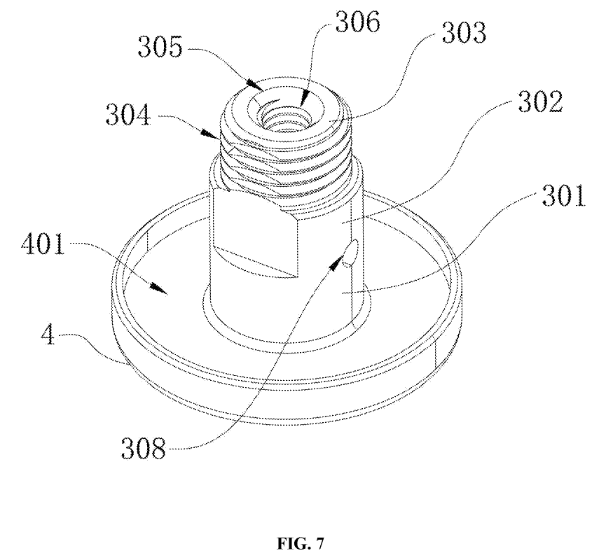

As shown in FIG. 7, the second shaft section 302 can be correspondingly set as a flat shaft, and correspondingly, a shape of the second connection hole 201 adapts to the second shaft section 302.

Correspondingly, the third shaft section can be set to have a smaller diameter to cause the third shaft section to smoothly pass through the second connection hole 201. Alternatively, the third shaft section 303 can also be set as a corresponding flat shaft, so that the third shaft section 303 can smoothly pass through the second connection hole 201.

In some embodiments, first anti-friction setting is performed between the stop cap portion 4 and the first blade 1. For example, a bearing is arranged between the stop cap portion 4 and the first blade 1, such as a plane bearing 9.

In some embodiments, a bearing positioning slot 401 corresponding to the plane bearing is formed in one side of the stop cap portion 4 that corresponds to the first blade. The plane bearing 9 is arranged on the bearing positioning slot 401, and an axis of the connection shaft 3 or an extension line of the axis is configured to pass through an axial internal channel of the plane bearing 9.

A first axial force-bearing end of the plane bearing 9 corresponds to the stop cap portion 4, and a second axial force-bearing end of the plane bearing 9 corresponds to the first blade 1. That is, the plane bearing 9 is located between the stop cap portion 4 and the first blade 1, and the stop cap portion 4 can compress the first blade 1 through the plane bearing 9.

When the first blade 1 rotates relative to the stop cap portion 4, the plane bearing 9 makes the first blade easier to rotate, thus avoiding direct contact and hard friction between the first blade 1 and the stop cap portion 4.

In some embodiments, the axis of the connection shaft 3 or the extension line of the axis overlaps an axial center line of the internal channel of the plane bearing 9.

In some embodiments, second anti-friction setting is performed between the first blade 1 and the second blade 2, such as adding lubrication grease or lubrication oil between the first blade 1 and the second blade 2.

In some embodiments, an oil storage slot 202 is formed in one side of the second blade 2 that corresponds to the first blade. The oil storage slot 202 extends in a direction close to the connection shaft 3.

An oil filling channel 307 is formed inside the connection shaft 3. The oil filling channel 307 has a side connection port 308 communicated with the oil storage slot 202. The oil filling channel 307 further has an oil filling port 309 that extends in a direction close to the stop cap portion and is formed in an outer side of the stop cap portion.

After the connection shaft 3 passes through the corresponding first connection hole 101 and second connection hole 201 on the first blade 1 and the second blade 2, and the first blade 1 is pressed against the second blade 2 by the stop cap portion 4 (or through the plane bearing 9), the side connection port 308 of the oil filling channel 307 is correspondingly communicated with the oil storage slot 202.

A user can fill lubrication grease or lubrication oil through the exposed oil filling port 309 on the stop cap portion. The lubrication grease or lubrication oil is filled into the oil storage slot 202 through the oil filling channel 307 to provide lubrication between the first blade 1 and the second blade 2. Meanwhile, the oil filling channel 307 forms an additional oil storage space, thus fully utilizing a volume occupied by the connection shaft 3 and the stop cap portion 4.

In some embodiments, a cover 310 or plug that can block the oil filling port is arranged on the stop cap portion 4. When oil filling is required, the cover 310 or plug can be opened or removed for oil filling. After the oil filling is completed, the cover 30 or plug is closed or mounted, to avoid or reduce oil spillage.

In some embodiments, the oil storage slot 202 has at least one lubrication guide slot 311 extending away from the connection shaft 3. During oil filling, the lubrication oil can also be correspondingly filled into the lubrication guide slot 311 through the oil storage slot 202.

The second blade 2 has a supporting surface 312 corresponding to the first blade 1. The lubrication guide slot 311 extends and protrudes into the supporting surface 312.

When the first blade 1 rotates relative to the second blade 2, at least one friction portion of the first blade 1 can be switched to correspond to the supporting surface 312 and the lubrication guide slot 311. When the friction portion is rotated to correspond to the lubrication guide slot 311, the lubrication oil in the lubrication guide slot 311 can be correspondingly attached to the friction portion. When the friction portion is rotated to correspond to the supporting surface 312 of the second blade, the lubrication oil attached to the friction portion can correspondingly reduce a frictional force between the friction portion and the supporting surface 312. Meanwhile, by the use of a supporting part, the lubrication guide slot 311 further enlarges an oil storage space and better reduces friction.

In some embodiments, the oil storage slot 202 is configured to be arranged around the outer circumferential surface of the connection shaft 3. That is, when the connection shaft 3 rotates along its axis for position adjustment, the oil storage slot 202 can maintain communication with the oil filling channel 307 after the connection shaft 3 rotates for position adjustment.

For example, when the second shaft section 302 is set as a flat shaft, the connection shaft 3 can rotate for position adjustment before being inserted into the first connection hole 101 and the second connection hole 201. After the position adjustment, the connection shaft 3 is inserted into the first connection hole 101 and the second connection hole 201. After the connection shaft 3 is mounted in place, the oil storage slot 202 can maintain communication with the oil filling channel 307.

In this embodiment, a pair of electric scissors is also provided. The electric scissors apply the scissors blade structure of any of the above embodiments. The electric scissors drive at least one blade (the first blade or the second blade) in the scissors blade structure to form a cutting action and a blade opening action.

In some embodiments, the electric scissors include a housing (not shown), a driving motor 10, a power transmission assembly 11, and a control unit 12. The driving motor 10 is controlled by the control unit 12 to work, and the driving motor 10 drives a corresponding blade to rotate through the power transmission assembly 11.

For those skilled in the art, it is apparent that the present disclosure is not limited to the details of the exemplary embodiments mentioned above, and can be implemented in other specific forms without departing from the spirit or basic features of the present disclosure. Therefore, in any perspective, the embodiments should be regarded as exemplary and non-restrictive. The scope of the present disclosure is limited by the accompanying claims rather than the above description. Therefore, all changes within the meaning and scope of the equivalent conditions of the claims within the present disclosure. Any reference numerals in the claims should not be regarded as limiting the claims involved.

What is claimed is:

1. A scissors blade structure, comprising a first blade, a second blade, and a connection structure, wherein the first blade and the second blade are rotatably connected through the connection structure; the connection structure comprises a connection shaft; the first blade is provided with a first connection hole that cooperates with the connection shaft; the second blade is provided with a second connection hole that cooperates with the connection shaft; one end of the connection shaft is connected with a stop cap portion corresponding to the first blade, and another end of the connection shaft is connected with a fastener after sequentially passing through the first connection hole and the second connection hole; the fastener corresponds to the second blade;
the connection shaft comprises a third shaft section that cooperates with the fastener;
the fastener is screwed to the third shaft section in an axial direction of the third shaft section, and is configured to move in a direction close to the stop cap portion and the second blade when the fastened is tightened;
an anti-detachment shaft is further arranged on the third shaft section, and is connected with an anti-detachment cap portion;
the anti-detachment shaft is screwed to the third shaft section in the axial direction of the third shaft section, and the anti-detachment cap portion is configured to move in a direction close to the stop cap portion and the fastener when the anti-detachment shaft is tightened; and
a thread direction of the anti-detachment shaft and a thread direction of the fastener are mutually in a left-hand thread setting.

2. The scissors blade structure according to claim 1, wherein the third shaft section has a first external thread formed on an outer circumferential surface of the third shaft section;
the fastener has a fastening hole corresponding to the third shaft section; the fastening hole penetrates through the fastener in an axial direction of the connection shaft; the fastening hole internally has a first internal thread that cooperates with the first external thread;
the third shaft section is an end portion of the connection shaft; the third shaft section correspondingly has an end surface; the end surface of the third shaft section is inwards sunken to form an anti-detachment hole; the anti-detachment hole internally has a second internal thread;
a second external thread that cooperates with the second internal thread is further provided on an outer circumferential surface of the anti-detachment shaft; and
the first internal thread and the second external thread are in left-hand thread setting.

3. The scissors blade structure according to claim 2, wherein the fastening hole has a far-end opening away from the stop cap portion and a near-end opening close to the stop cap portion;
a guide sliding chute communicated with the far-end opening is formed in one side of the fastener that is away from the stop cap portion, and the guide sliding chute extends on the fastener in the axial direction of the connection shaft;
the fastener is further provided with an axial transition member; the axial transition member is configured to be threaded into the fastening hole from the far-end opening; the axial transition member is provided with a positioning portion that cooperates with the guide sliding chute;
the anti-detachment shaft is screwed to the third shaft section in the axial direction on the third shaft section; the anti-detachment cap portion is configured to push the axial transition member in a direction close to the stop cap portion when the anti-detachment shaft is tightened; and
the axial transition member is further configured to push the anti-detachment cap portion onto the third shaft section by the anti-detachment cap portion.

4. The scissors blade structure according to claim 3, wherein the fastener has an extension portion extending beyond the third shaft section in a direction away from the stop cap portion, and both the fastening hole and the guide sliding chute extend to be opened in the extension portion.

5. The scissors blade structure according to claim 3, wherein a via hole corresponding to the anti-detachment shaft penetrates through the axial transition member, and the anti-detachment shaft is correspondingly threaded into the anti-detachment hole after passing through the via hole.

6. The scissors blade structure according to claim 5, wherein the anti-detachment cap portion has an anti-detachment slope that is in contact with the axial transition member; the anti-detachment slope tilts in a direction close to the anti-detachment cap portion and towards the anti-detachment shaft; and
the axial transition member has a contact slope that cooperates with the anti-detachment slope.

7. The scissors blade structure according to claim 1, wherein the connection shaft further comprises a second shaft section that cooperates with the second connection hole; the second shaft section is configured as a flat shaft; and a shape of the second connection hole adapts to the second shaft section.

8. The scissors blade structure according to claim 1, wherein a plane bearing is arranged between the stop cap portion and the first blade;
a bearing positioning slot corresponding to the plane bearing is formed in one side of the stop cap portion that corresponds to the first blade; and the plane bearing is arranged on the bearing positioning slot.

9. The scissors blade structure according to claim 1, wherein an oil storage slot is formed in one side of the second blade that corresponds to the first blade; the oil storage slot extends in a direction close to the connection shaft;
an oil filling channel is formed inside the connection shaft; the oil filling channel has a side connection port communicated with the oil storage slot; the oil filling channel further has an oil filling port that extends in a direction close to the stop cap portion and is formed in an outer side of the stop cap portion;
the oil storage slot has at least one lubrication guide slot extending in a direction away from the connection shaft; the second blade has a supporting surface corresponding to the first blade; and the lubrication guide slot extends and protrudes into the supporting surface.

10. A pair of electric scissors, comprising a scissors blade structure, wherein the scissors blade structure comprises a first blade, a second blade, and a connection shaft; the first blade and the second blade are rotatably connected through the connection structure; the connection structure comprises a connection shaft; the first blade is provided with a first connection hole that cooperates with the connection shaft; the second blade is provided with a second connection hole that cooperates with the connection shaft; one end of the connection shaft is connected with a stop cap portion corresponding to the first blade, and another end of the connection shaft is connected with a fastener after sequentially passing through the first connection hole and the second connection hole; the fastener corresponds to the second blade;
the connection shaft comprises a third shaft section that cooperates with the fastener;
the fastener is screwed to the third shaft section in an axial direction of the third shaft section, and is configured to move in a direction close to the stop cap portion and the second blade when the fastened is tightened;
an anti-detachment shaft is further arranged on the third shaft section, and is connected with an anti-detachment cap portion;
the anti-detachment shaft is screwed to the third shaft section in the axial direction of the third shaft section, and the anti-detachment cap portion is configured to move in a direction close to the stop cap portion and the fastener when the anti-detachment shaft is tightened; and
a thread direction of the anti-detachment shaft and a thread direction of the fastener are mutually in a left-hand thread setting.
